(19) United States
(12) Patent Application Publication
(10) Pub. No.: US 2018/0189828 A1
(43) Pub. Date: Jul. 5, 2018

(54) COMPUTERIZED GENERATION OF MUSIC TRACKS TO ACCOMPANY DISPLAY OF DIGITAL VIDEO ADVERTISEMENTS

(71) Applicant: Criteo SA, Paris (FR)

(72) Inventors: Benoit Luce, Paris (FR); Clément Créteur, Paris (FR); Sami Touil, Paris (FI)

(21) Appl. No.: 15/398,339

(22) Filed: Jan. 4, 2017

(51) Int. Cl. G06Q 30/02

(52) U.S. Cl. CPC G06Q 30/0254

(57) ABSTRACT

A computing device receives a request for a digital video advertisement from a user device and determines a digital video advertisement based upon the request. The computing device determines one or more attributes associated with the advertisement, and identifies one or more candidate music tracks based upon the one or more attributes associated with the advertisement. For each candidate music track, the computing device determines a probability of a user interaction with the advertisement, the probability based upon the one or more attributes associated with the digital video advertisement and the candidate music track. The computing device selects one of the candidate music tracks based upon the determined probability for each of the candidate music tracks. The computing device associates the selected music track with the advertisement and transmits the advertisement and the selected music track to the user device for playback.

### TECHNICAL FIELD

The present technology relates to methods and systems for computerized generation of music tracks to accompany display of digital video advertisements on computing devices.

### BACKGROUND

Online and other electronic advertising allows advertisers and publishers to display video advertisements (or video ads) to end users, including those who are potential customers. For example, an application can include one or more opportunities for inserting video advertisements (e.g., prerolls, overlays, etc.). When a computing device (e.g., a mobile computing device such as a phone or tablet) is running an application in the foreground, an advertising opportunity can arise within the application. The application can request a video advertisement from an advertising decision server (or ad decision server) for the advertising opportunity. The ad decision server can select a video ad for display within the area of the application display associated with the advertising opportunity. For example, the ad decision server can select a video ad from a particular advertiser from a set of multiple video ads from multiple advertisers for display to the user in the advertising opportunity of the application.

In some instances, the advertising creative can be accompanied by a music track that plays in conjunction with the video ad. The music track can have certain characteristics and features (e.g., tempo, chord progression, style, etc.). The ad decision server typically selects a pre-existing music track from a library of music tracks and transmits it to the application along with the video ad.

### SUMMARY

Generally, however, based upon the context of the video ad—such as the advertiser, the product(s), the viewer, and so forth—certain music tracks, or characteristics and features of music tracks, may result in improved performance of the video ad. For example, a video ad that includes a corresponding music track may result in increased user interaction with the ad (e.g., views, clicks, website visits, conversions, and the like). What is needed are methods and systems to analyze the context of a video ad and the characteristics and features of the corresponding music track to generate a score for the music track that is associated with the performance of the related video ad, in order to determine certain features or characteristics of music tracks that exhibit better performance. Also, what is needed are methods and systems to programmatically create new music tracks, using snippets of music tracks, that have characteristics and features which are predicted to result in improved performance of the video ad.

In one aspect, there is a computer-implemented method of generating a music track for playback in conjunction with display of a digital video advertisement. A computing device receives a request for a digital video advertisement from a user device and determines a digital video advertisement based upon the request. The computing device determines one or more attributes associated with the digital video advertisement and identifies one or more candidate music tracks based upon the one or more attributes associated with the digital video advertisement. For each candidate music track, the computing device determines a probability of a user interaction with the digital video advertisement. The probability is based upon the one or more attributes associated with the digital video advertisement and the candidate music track. The computing device selects one of the candidate music tracks based upon the probability for each of the candidate music tracks. The computing device associates the selected music track with the digital video advertisement, and transmits the digital video advertisement and the selected music track to the user device for playback.

In another aspect, there is a computerized system for generating a music track for playback in conjunction with display of a digital video advertisement. The system comprises a computing device configured to receive a request for a digital video advertisement from a user device and determine a digital video advertisement based upon the request. The computing device is configured to determine one or more attributes associated with the digital video advertisement and identify one or more candidate music tracks based upon the one or more attributes associated with the digital video advertisement. For each candidate music track, the computing device is configured to determine a probability of a user interaction with the digital video advertisement. The probability is based upon the one or more attributes associated with the digital video advertisement and the candidate music track. The computing device is configured to select one of the candidate music tracks based upon the probability for each of the candidate music tracks. The computing device is configured to associate the selected music track with the digital video advertisement, and transmit the digital video advertisement and the selected music track to the user device for playback.

Any of the above aspects can include one or more of the following features. In some embodiments, the one or more attributes associated with the digital video advertisement comprise: attributes of the digital video advertisement, attributes of the user device, attributes of a user of the user device, attributes of one or more products associated with the digital video advertisement, and attributes of one or more advertisers associated with the digital video advertisement. In some embodiments, the attributes of the digital video advertisement comprise: video size, length, playback features, layout metadata, frames per second, and display dimensions. In some embodiments, the attributes of the user device comprise: browser attributes, operating system attributes, hardware attributes, and networking attributes. In some embodiments, the attributes of a user of the user device comprise: attributes of past user interactions with one or more advertisements, and attributes of past user interactions with one or more websites. In some embodiments, the past user interactions with one or more advertisements comprise: an ad view event, an ad click event, an ad skip event, an ad start event, an ad first quartile event, an ad midpoint event, an ad third quartile event, and an ad complete event. In some embodiments, the past user interactions with one or more websites comprise: a product listing event, a product view event, a cart view event, an add-to-cart event, and a conversion event. In some embodiments, the one or more websites comprise: an e-commerce site, a travel site, and a classified site.

In some embodiments, the attributes of the one or more products associated with the digital video advertisement comprise: product category, product brand, product price, product availability, product ratings, and discount. In some embodiments, the step of determining a probability of a user interaction with the digital video advertisement comprises determining, by the computing device, a score for each candidate music track based upon the one or more attributes associated with the digital video advertisement, the score representing a predicted probability of interaction by a user with the digital video advertisement. In some embodiments, the step of selecting one of the candidate music tracks comprises selecting, by the computing device, a candidate music track having a highest score of the scores for the candidate music tracks. In some embodiments, the step of selecting one of the candidate music tracks comprises selecting, by the computing device, a candidate music track having a score lower than a highest score of the scores for the candidate music tracks. In some embodiments, the step of selecting one of the candidate music tracks comprises selecting, by the computing device, a random candidate music track of the candidate music tracks having a score lower than a highest score of the scores for the candidate music tracks.

In some embodiments, the score for each candidate music track is further based upon one or more musical characteristics of the candidate music track. In some embodiments, the one or more musical characteristics of the candidate music track comprise: tempo, pattern repetition, style, amplitude, chords used, rhythm, and tone. In some embodiments, the computing device automatically generates the one or more musical characteristics for each candidate music track by analyzing the candidate music track. In some embodiments, the computing device automatically generates the one or more candidate music tracks by combining a plurality of music track snippets into one or more candidate music tracks. In some embodiments, each of the plurality of music track snippets is associated with one or more musical characteristics. In some embodiments, the computing device automatically generates the one or more musical characteristics for each of the plurality of music track snippets by analyzing the plurality of music track snippets. In some embodiments, the computing device combines the plurality of music track snippets according to rules evaluated against the one or more musical characteristics.

In some embodiments, the step of associating the selected music track with the digital video file comprises synchronizing, by the computing device, the selected music track with the digital video advertisement. In some embodiments, an event in the digital video advertisement is synchronized with an event in the selected music track. In some embodiments, the computing device selects a plurality of the candidate music tracks based upon the determined probability of a user interaction for each of the candidate music tracks.

Other aspects and advantages of the present technology will become apparent from the following detailed description, taken in conjunction with the accompanying drawings, illustrating the principles of the technology by way of example only.

### BRIEF DESCRIPTION OF THE DRAWINGS

The foregoing and other objects, features, and advantages of the present technology, as well as the technology itself, will be more fully understood from the following description of various embodiments, when read together with the accompanying drawings, in which:

FIG. 1 is a diagram of a networked system in accordance with embodiments of the technology.

FIG. 2 is a detailed diagram of the ad system of FIG. 1 in accordance with embodiments of the technology.

FIG. 3 is a flow diagram of a method of generating a music track for playback in conjunction with display of a digital video advertisement.

FIGS. 4A and 4B comprise a workflow diagram for generation of music tracks from a plurality of music track snippets.

### DETAILED DESCRIPTION

The present technology provides systems and methods for generation of music tracks to accompany display of digital video advertisements on computing devices. Although the technology is illustrated and described herein with reference to specific embodiments, the technology is not intended to be limited to the details shown. Various modifications can be made in the details within the scope the claims and without departing from the technology.

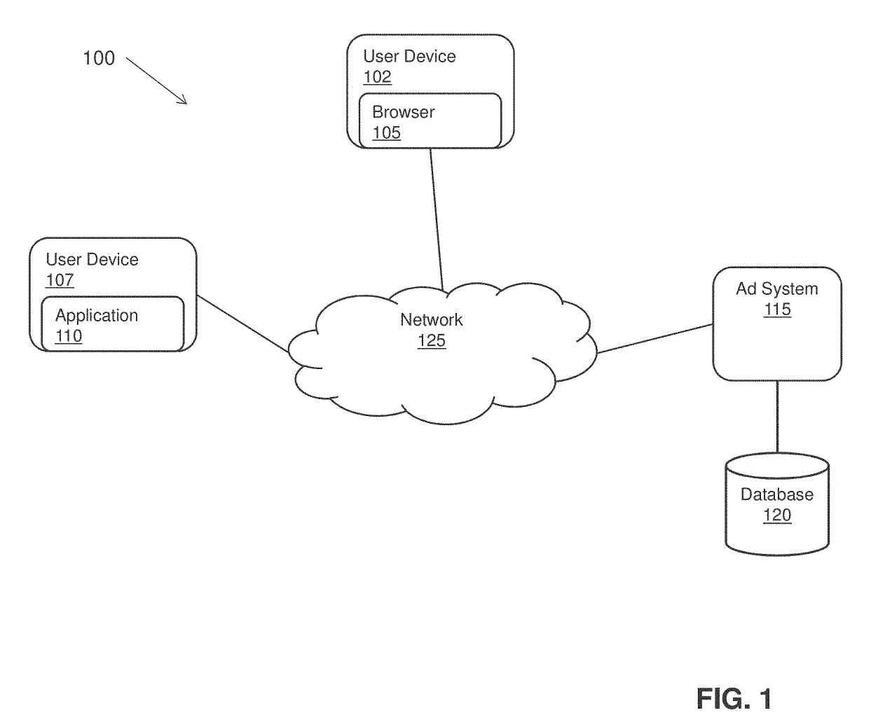

FIG. 1 is a diagram of networked system 100 in accordance with embodiments of the technology. As illustrated, networked system 100 can include user devices 102 and 107, server computing device 110, ad system 115, and database 120. User devices 102 and 107, server computing device 110, ad system 115, and database 120 can be in data communication via network 125. User devices 102 and 107 can be any computing device. In some embodiments, user devices 102 and 107 can be a mobile computing device (e.g., cellular phones and/or tablets), a PC, or other computing device. User device 102 executes web browser 105. User device 107 executes application 110 (e.g., a mobile application that interacts with online content).

Ad system 115 can be any computing device, such as a server or multiple servers. In some embodiments, ad system 115 can collect behavioral data for a plurality of devices, browsers, and/or applications. In some embodiments, ad system 115 can receive behavioral data for a plurality of devices, browsers, and/or applications from third-parties. In some embodiments, ad system 115 can provide a video ad and corresponding music track in accordance with the present technology as described herein.

Database 120 is a computing device (or in some embodiments, a set of computing devices) coupled to ad system 115 and is configured to receive, generate, and store specific segments of data relating to the processes described herein. In some embodiments, all or a portion of database 120 can be integrated with ad system 115 or be located on a separate computing device or devices. The database 120 can comprise one or more databases (e.g., including data structures, tables, schema, and the like) configured to store portions of data used by the other components of the system 100, as will be described in greater detail below.

Network 125 can be any network or multiple networks. For example, network 125 can include cellular networks through which user devices 102 and 107 are connected and the Internet.

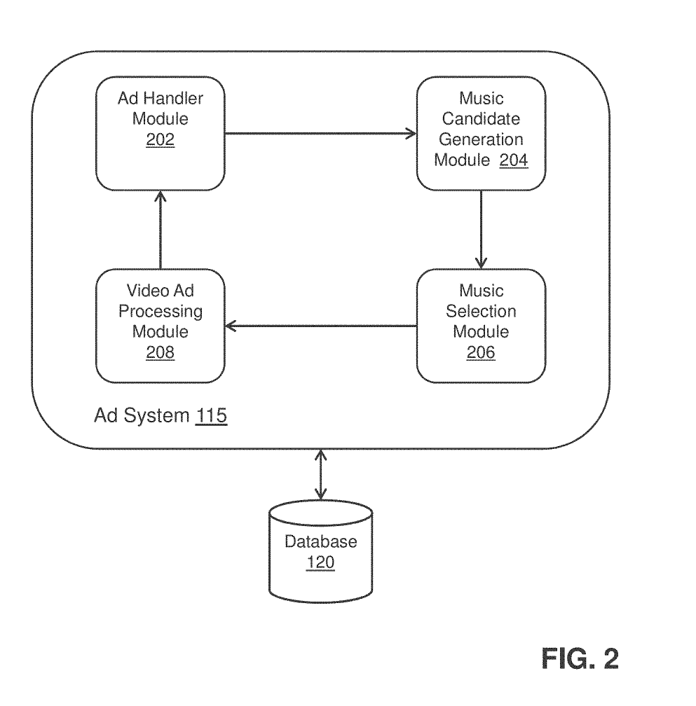

FIG. 2 is a detailed diagram of the ad system 115 of FIG. 1. As shown in FIG. 2, the ad system 115 includes an ad handler module 202, a music candidate generation module 204, a music selection module 206, and a video ad processing module 208. Ad system 115 is a computing device that includes specialized hardware and/or software modules that execute on a processor and interact with memory modules (e.g., local memory and database 120), to receive data from other components of the system 100, transmit data to other components of the system 100, and perform other functions as described herein. Ad system 115 includes the computing modules 202, 204, 206, 208 that execute on one or more processors of ad system 115. In some embodiments, modules 202, 204, 206, 208 are specialized sets of computer software instructions programmed onto one or more dedicated processors in ad system 115 and can include specifically-designated memory locations and/or registers for executing the specialized computer software instructions.

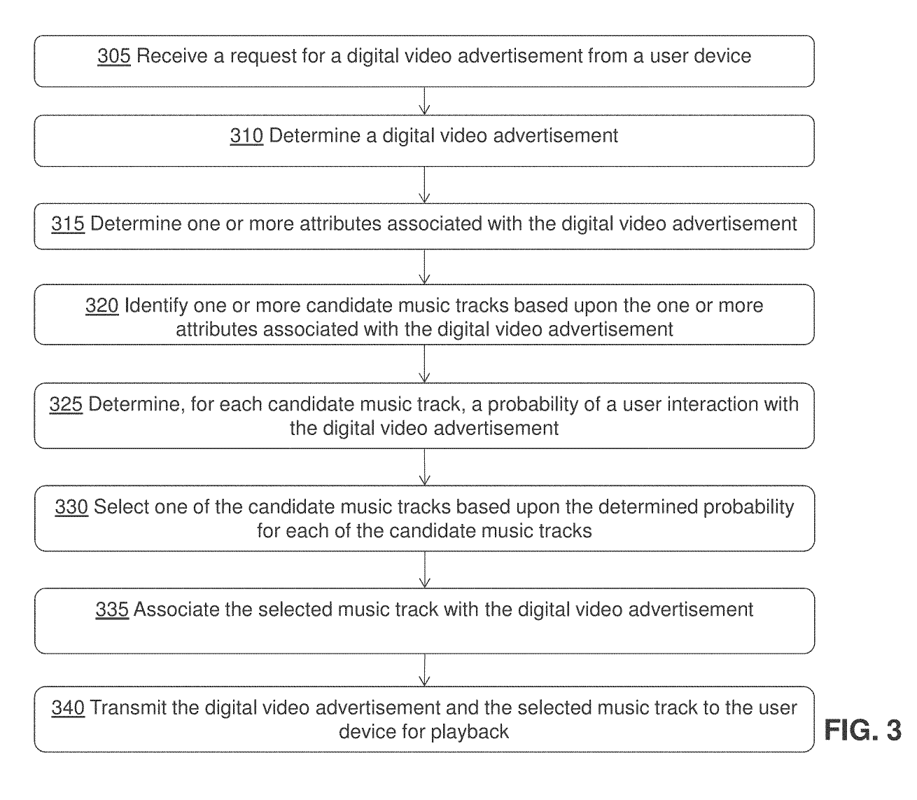

In some embodiments, the functionality of modules 202, 204, 206, 208 can be distributed among a plurality of server computing devices that comprise ad system 115. As shown in FIG. 2, the modules 202, 204, 206, 208 communicate with each other in order to exchange data for the purpose of performing the described functions. It should be appreciated that any number of computing devices, arranged in a variety of architectures, resources, and configurations (e.g., cluster computing, virtual computing, cloud computing) can be used without departing from the scope of the invention. The exemplary functionality of modules 202, 204, 206, 208 is described in detail below with respect to FIG. 3.

FIG. 3 is a flow diagram of a method of generating a music track for playback in conjunction with display of a digital video advertisement, using the system 100 of FIG. 1 and the ad system 115 as depicted in FIG. 2. At step 305, ad handler module 202 of ad system 115 receives a request for a digital video advertisement from a user device (e.g., user device 102 and/or user device 107). A browser (e.g., browser 105 of user device 102) or application (e.g., application 110 of user device 107) can transmit a request for a digital video advertisement to ad system 115 based upon availability of an advertising impression opportunity (i.e., an ad slot) on the user device. For example, if a user at user device 102 has navigated to a particular webpage that includes an impression opportunity on a portion of the webpage, the browser 105 can generate and transmit a request to ad system 115 for a digital video ad to be placed in the impression opportunity. The request can include one or more identifiers. For example, the identifiers can identify user device 102, 107 and/or a user of user device 102, 107. In some embodiments, the identifiers can include a user ID and/or a device ID. The request can include information for use by ad system 115 in selecting a video ad to be placed in the impression opportunity. For example, the request can include application data (e.g., data related to an application running on the user device that is sending the request), sensor data (e.g., data collected by sensors on the user device), computing device data (e.g., data related to the user device, such as its type, hardware, operating system, etc.), tracking data (e.g., data related to activity by the user of the user device, such as retailer websites visited and/or products viewed), and user device location data (e.g., data related to the location of the user device). In some embodiments, the request can be sent by an application running in the background on the user device.

At step 310, ad handler module 202 determines a digital video advertisement based upon the request, including the data associated with the request. In one embodiment, ad handler module communicates with a content delivery network (CDN) and/or a publisher system to select a digital video ad to be placed in the impression opportunity from a plurality of digital video ads.

At step 315, ad handler module 202 determines one or more attributes associated with the digital video advertisement. Exemplary attributes include, but are not limited to, attributes of the publisher displaying the video (e.g., website or application URL), attributes of the video ad being displayed (e.g., file size, length playback features (i.e., can it be skipped?), layout metadata, frames per second, and display dimensions), attributes of the user device (e.g., applications, operating system, hardware platform, networking capabilities), attributes of products displayed in the video ad (e.g., product category, product brand, product price, product availability, product ratings, and discount), and attributes of the user (e.g., attributes of past user interactions with one or more video ads or other ads, attributes of past user interactions with one or more websites). In some embodiments, the past user interactions with one or more video ads can include an ad view event, an ad click event, an ad skip event, an ad start event, an ad first quartile event, an ad midpoint event, an ad third quartile event, and an ad complete event. For example, the ad handler module can receive an indication that a particular event associated with one or more video ads has occurred, either with respect to a prior ad displayed to the user or a current ad being displayed to the user. In some cases, the event occurs automatically as the video ad is being played back to the user—e.g., when the ad starts playback, when the ad playback reaches 25% complete (first quartile), 50% complete (midpoint), 75% complete (third quartile), and 100% complete.

In some embodiments, the past user interactions with one or more websites can include a product listing event (i.e., the user viewed a list of products on an advertiser webpage), a product view event (i.e., the user viewed a particular product on an advertiser webpage), a cart view event (i.e., the user viewed a shopping cart associated with an advertiser webpage), an add-to-cart event (i.e., the user added a product to a cart associated with an advertiser webpage), and a conversion event (i.e., the user purchased a product on an advertiser webpage). The websites can comprise e-commerce sites, travel sites, and classified sites. Additional attributes can include data elements such as temporal attributes (e.g., day/time of the user's location), geographic attributes (e.g., where the user is located), and historical attributes associated with the user's activity (e.g., features of products that the user has viewed in the past, number of products the user has viewed in the last week, number of video as that the user has viewed in the past day).

Ad handler module 202 can also determine one or more constraints to be applied to a music track selected or generated for association with the video ad. For example, an advertiser may want to select and/or generate music tracks that have a certain quality or characteristics (e.g., tempo, genre, instruments, etc.). In another example, the system may want to ensure that generated music tracks are valid, e.g., generating a twenty-second music track using a one beat-per-minute tempo layer would result in only one beat. Ad handler module can transmit these constraints to the music candidate generation module 204 along with the above-mentioned attributes associated with the video ad.

At step 320, music candidate generation module 204 receives the constraints from ad handler module and identifies one or more candidate music tracks based upon the one or more attributes associated with the digital video advertisement. In one example, in identifying one or more candidate music tracks, music candidate generation module selects precompiled music tracks from, e.g., a library of precompiled music tracks—for example, as stored in database 120. The precompiled music tracks can each have a unique ID number (mID) and, in some embodiments, the precompiled music tracks have corresponding metadata associated with them. For example, a music track can have certain characteristics such as: tempo (e.g., beats per minute or bpm), pattern repetition (e.g., one repeated pattern, multiple patterns), chords used, amount of notes played, spacing of notes, tone/timbre, amplitude, rhythm, frequencies, style (e.g., jazz, rock, pop), effects (e.g., delay, reverb), envelope, melody, and the like. The system can assign metadata to each music track that corresponds to these characteristics, so that the system can evaluate the metadata when identifying candidate music tracks for selection.

In some embodiments, the metadata is assigned in advance (e.g., based upon manually-determined characteristics) and stored in database 120. In some embodiments, the system automatically generates the music track metadata for storage in the database (e.g., by processing the music track through an audio analyzer, which uses elements such as waveform analysis, audio fingerprinting or sample matching, instrument signatures, and the like to extract certain features and generate the corresponding metadata).

Another example of the music candidate generation module 204 identifying one or more candidate music tracks is generating new music tracks by layering together and compiling one or more music track snippets. A music track snippet is a subset of a music track, such as a drum sequence, a bass line, a chord part, and the like. Music candidate generation module can retrieve one or more music track snippets, e.g., from database 120 and layer them together to generate a new candidate music track. Like the precompiled music tracks mentioned above, these music track snippets can similarly have metadata associated with them, and the system can use the metadata when generating the new music tracks. For example, music candidate generation module can apply rules to exclude certain invalid combinations of snippets—such as combining two snippets that have different tempos (e.g., a bassline at 90 bpm and a drum sequence at 120 bpm), or combining two snippets that are in different musical keys (e.g., a minor chords guitar snippet and a major chords bassline snippet). When generating the new candidate music tracks from the music track snippets, music candidate generation module 204 can generate a large number of different combinations of snippets and layer each combination together into a new music track, then associate the new music track with its corresponding metadata (e.g., by using the metadata from the underlying snippets and/or analyzing the new music track with an audio analyzer as described above).

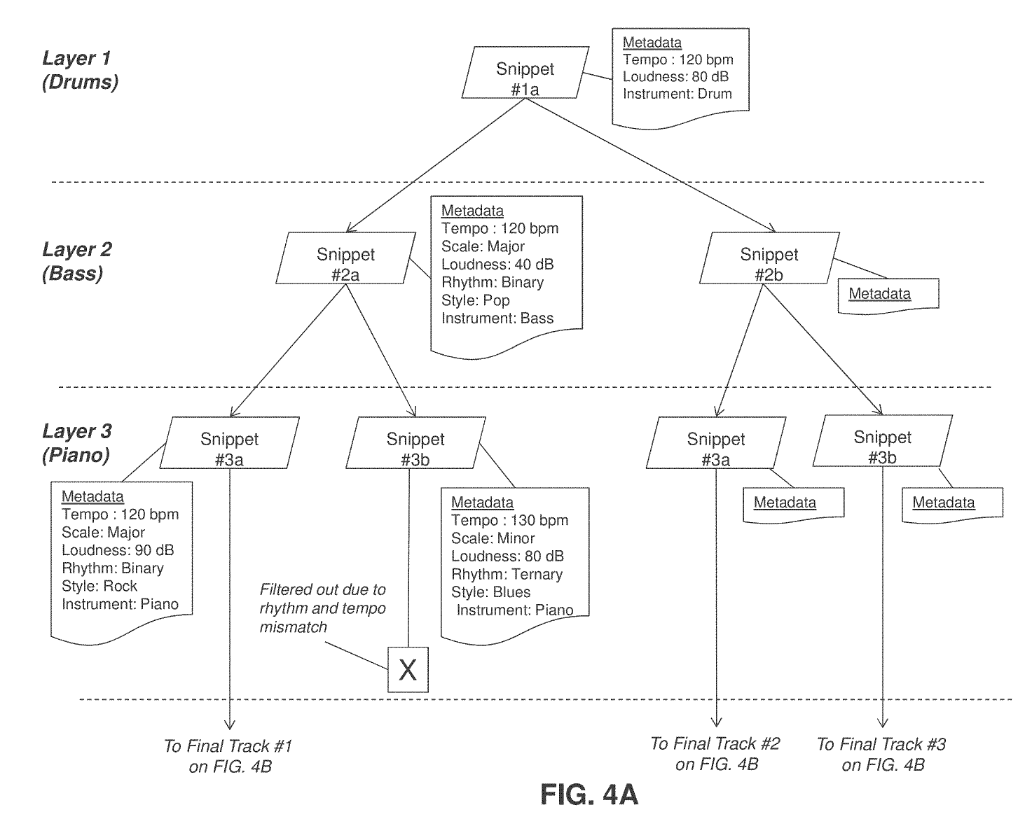

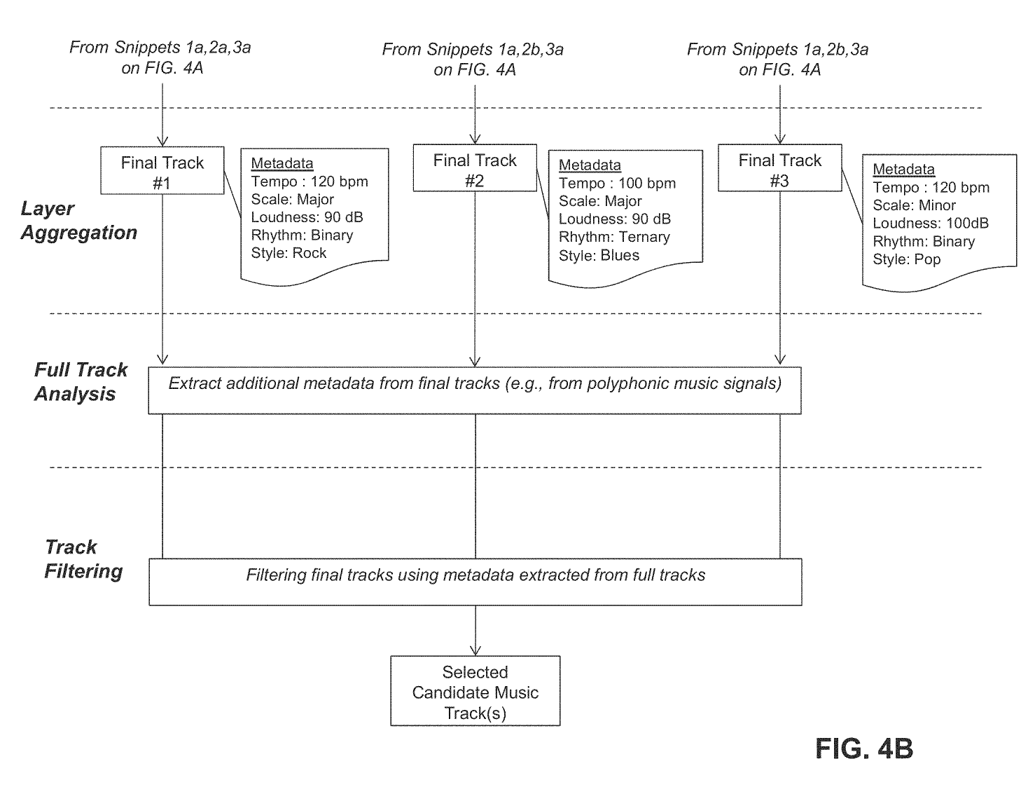

FIGS. 4A and 4B comprise a workflow diagram for generation of music tracks from a plurality of music track snippets by the music candidate generation module 204. The music candidate generation module begins generation of new music tracks by selecting one or more snippets associated with a first layer of the music track. As shown in FIG. 4A, Layer 1 corresponds to drum track snippets (e.g., Snippet #1a) and each drum track snippet has a set of metadata that describes certain attributes of the snippet (e.g., Snippet #1a has a tempo of 120 bpm, a loudness of 80 dB, and a drum instrument type). The music candidate generation module then adds one or more second layer snippets to the first layer snippet. As shown in FIG. 4A, Layer 2 corresponds to bass track snippets (e.g., Snippet #2a, Snippet #2b) and each bass track snippet has a set of metadata that describes certain attributes of the snippet (e.g., Snippet #2a has a tempo of 120 bpm, a major scale, a loudness of 40 dB, a binary rhythm, a pop style, and a bass instrument type). In some embodiments, the music candidate generation module layers each of Snippet #2a and Snippet #2b on top of Snippet #1a to generate a plurality of differently layered music tracks.

Next, the music candidate generation module adds one or more third layer snippets to the layered music tracks that comprise the first and second layer snippets. As shown in FIG. 4A, Layer 3 corresponds to piano track snippets (e.g., Snippet #3a, Snippet #3b) and each piano track snippet has a set of metadata that describes certain attributes of the snippet (e.g., Snippet #3a has a tempo of 120 bpm, a major scale, a loudness of 90 dB, a binary rhythm, a rock style, and a piano instrument type). In some embodiments, the music candidate generation module layers each of the piano track snippets on top of each combination of the previous layers' snippets to generate a plurality of differently layered music tracks.

Also, in some instances, certain combinations of snippets may be filtered out due to, e.g., incompatibilities of the respective snippets' metadata. For example, Snippet #3b has a tempo of 130 bpm and a ternary rhythm while Snippet #2a has a tempo of 120 bpm and a binary rhythm. As a result, these two snippets Snippet #2a and Snippet #3b are mismatched and therefore incompatible, and the music candidate generation module does not proceed further to generate a final music track based upon this combination of snippets.

Turning to FIG. 4B, once music candidate generation module 204 has layered the various combinations of snippets, the music candidate generation module generates one or more final music tracks (e.g., Final Track #1, Final Track #2, Final Track #3) and each final music track has a set of metadata that describes certain attributes of the music track (e.g., Final Track #1 has a tempo of 120 bpm, a major scale, a loudness of 90 dB, a binary rhythm, and a rock style). The music candidate generation module then analyzes each final music track (e.g., using an audio analyzer) to extract additional musical metadata from the track—for example, the music candidate generation module can analyze polyphonic music signals from each track to generate additional metadata. Then, using the additional metadata, the music candidate generation module can filter the final music tracks to select one or more music tracks as candidate music tracks.

Once music candidate generation module 204 has identified one or more candidate music tracks, music selection module 206 determines, for each candidate music track, a probability of a user interaction with the digital video advertisement based upon the one or more attributes associated with the digital video advertisement and the candidate music track. As mentioned above, a video ad that includes a corresponding music track may result in increased user interaction with the ad. Accordingly, music candidate generation module 204 uses a prediction modeling framework to score each candidate music track based upon the probability of a user interaction. For example, the framework can generate a model by running a logistical regression against historical user interaction data (e.g., which music tracks or characteristics of music tracks were historically associated with video ads that received a user interaction event) and leverage the model to generate a function that can compute a score for subsequent music tracks based upon the specific attributes associated with the video ad, where the score reflects a probability of a user interaction with the video ad if it is associated with that music track. In one example, the function can be f(Ca, Cu, mID)=>pInt, where Ca corresponds to attributes associated with the video ad, Cu corresponds to attributes associated with a user (or viewer) of the ad, mID is the unique identifier for the music track being scored, and pInt is the probability score for the music track.

In another example, the framework can incorporate the musical metadata associated with each music track, instead of the mID, to generate the probability score. In this case, the function can be f(Ca, Cu, metadata1, metadata2, . . . , metadataN)=>pInt. As such, the framework uses a more complex, multidimensional model to generate a more refined probability score. In addition, it should be appreciated that for either of the above functions, the probability score can reflect a probability of any user interaction or a probability of a particular user interaction (e.g., ad view, ad click, ad skip, page view, cart view, product view, conversion, and so forth). In this way, the system can predict the probability of specific user interactions based upon particular music tracks or characteristics of music tracks.

At step 330, music selection module 206 selects at least one of the identified candidate music tracks based upon the determined probability of a user interaction for that candidate music track. In one embodiment, music selection module can select a candidate music track using a predefined selection strategy. For example, the predefined selection strategy can be to select the highest-scoring candidate music track 95% of the time, and select a random candidate music track 5% of the time. In this example, the selection of a random candidate music track is useful as an exploration strategy to determine how certain types of music tracks perform and identity potential music tracks and/or characteristics of music tracks that may indicate increased performance.

At step 335, video ad processing module 208 associates the selected candidate music track and the digital video advertisement. In one example, video ad processing module 208 concatenates the digital video advertisement and the selected music track together into a single digital media file and transmits the file to ad handler module 202. In another example, video ad processing module can transmit the video ad and the music track independently (e.g., as separate streams) to the ad handler module. Video ad processing module 208 can synchronize the video ad and the music track (e.g., align the video ad and the music track so that certain musical features occur at relevant points during playback of the video ad).

At step 340, ad handler module transmits the digital video advertisement and the at least one candidate music track to the user device for playback (e.g., by displaying the video on a screen of user device and playing the music track through an audio playback device of the user device).

The above-described techniques can be implemented in digital electronic circuitry, or in computer hardware, firmware, software, or in combinations of them. The implementation can be as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps can be performed by one or more programmable processors executing a computer program to perform functions of the technology by operating on input data and generating output. Method steps can also be performed by, and apparatus can be implemented as, special purpose logic circuitry, e.g., an FPGA (field programmable gate array) or an ASIC (application specific-integrated circuit). Modules can refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor receives instructions and data from a read-only memory or a random access memory or both. The essential elements of a computer are a processor for executing instructions and one or more memory devices for storing instructions and data. Generally, a computer also includes, or be operatively coupled to receive data from or transfer data to, or both, one or more mass storage devices for storing data, e.g., magnetic, magneto-optical disks, or optical disks. Data transmission and instructions can also occur over a communications network. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

To provide for interaction with a user, the above described techniques can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The above described techniques can be implemented in a distributed computing system that includes a back-end component, e.g., as a data server, and/or a middleware component, e.g., an application server, and/or a front-end component, e.g., a client computer having a graphical user interface and/or a Web browser through which a user can interact with an example implementation, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet, and include both wired and wireless networks.

The computing system can include clients and servers. A client and server are generally remote from each other and typically interact through a communication network. The relationship of client and server arises by virtue of computer programs running on the respective computers and having a client-server relationship to each other.

The technology has been described in terms of particular embodiments. The alternatives described herein are examples for illustration only and not to limit the alternatives in any way. The steps of the technology can be performed in a different order and still achieve desirable results. Other embodiments are within the scope of the following claims.

What is claimed is:

1. A computer-implemented method of generating a music track for playback in conjunction with display of a digital video advertisement, the method comprising:
receiving, by a computing device, a request for a digital video advertisement from a user device;
determining, by the computing device, a digital video advertisement based upon the request;
determining, by the computing device, one or more attributes associated with the digital video advertisement;
identifying, by the computing device, one or more candidate music tracks based upon the one or more attributes associated with the digital video advertisement;
for each candidate music track, determining, by the computing device, a probability of a user interaction with the digital video advertisement, the probability based upon the one or more attributes associated with the digital video advertisement and the candidate music track;
selecting, by the computing device, one of the candidate music tracks based upon the probability for each of the candidate music tracks;
associating, by the computing device, the selected music track with the digital video advertisement; and
transmitting, by the computing device, the digital video advertisement and the selected music track to the user device for playback.

2. The method of claim 1, wherein the one or more attributes associated with the digital video advertisement comprise: attributes of the digital video advertisement, attributes of the user device, attributes of a user of the user device, attributes of one or more products associated with the digital video advertisement, and attributes of one or more advertisers associated with the digital video advertisement.

3. The method of claim 2, wherein the attributes of the digital video advertisement comprise:
video size, length, playback features, layout metadata, frames per second, and display dimensions.

4. The method of claim 2, wherein the attributes of the user device comprise: browser attributes, operating system attributes, hardware attributes, and networking attributes.

5. The method of claim 2, wherein the attributes of a user of the user device comprise: attributes of past user interactions with one or more advertisements, and attributes of past user interactions with one or more websites.

6. The method of claim 5, wherein the past user interactions with one or more advertisements comprise: an ad view event, an ad click event, an ad skip event, an ad start event, an ad first quartile event, an ad midpoint event, an ad third quartile event, and an ad complete event.

7. The method of claim 5, wherein the past user interactions with one or more websites comprise: a product listing event, a product view event, a cart view event, an add-to-cart event, and a conversion event.

8. The method of claim 7, wherein the one or more websites comprise: an e-commerce site, a travel site, and a classified site.

9. The method of claim 2, wherein the attributes of the one or more products associated with the digital video advertisement comprise: product category, product brand, product price, product availability, product ratings, and discount.

10. The method of claim 1, wherein the step of determining a probability of a user interaction with the digital video advertisement comprises determining, by the computing device, a score for each candidate music track based upon the one or more attributes associated with the digital video advertisement, the score representing a predicted probability of interaction by a user with the digital video advertisement.

11. The method of claim 10, wherein the step of selecting one of the candidate music tracks comprises selecting, by the computing device, a candidate music track having a highest score of the scores for the candidate music tracks.

12. The method of claim 10, wherein the step of selecting one of the candidate music tracks comprises selecting, by the computing device, a candidate music track having a score lower than a highest score of the scores for the candidate music tracks.

13. The method of claim 12, wherein the step of selecting one of the candidate music tracks comprises selecting, by the computing device, a random candidate music track of the candidate music tracks having a score lower than a highest score of the scores for the candidate music tracks.

14. The method of claim 10, wherein the score for each candidate music track is further based upon one or more musical characteristics of the candidate music track.

15. The method of claim 14, wherein the one or more musical characteristics of the candidate music track comprise: tempo, pattern repetition, style, amplitude, chords used, rhythm, and tone.

16. The method of claim 14, further comprising automatically generating, by the computing device, the one or more musical characteristics for each candidate music track by analyzing the candidate music track.

17. The method of claim 1, further comprising automatically generating, by the computing device, the one or more candidate music tracks by combining a plurality of music track snippets into one or more candidate music tracks.

18. The method of claim 17, wherein each of the plurality of music track snippets is associated with one or more musical characteristics.

19. The method of claim 18, further comprising automatically generating, by the computing device, the one or more musical characteristics for each of the plurality of music track snippets by analyzing the plurality of music track snippets.

20. The method of claim 17, further comprising combining, by the computing device, the plurality of music track snippets according to rules evaluated against the one or more musical characteristics.

21. The method of claim 1, wherein the step of associating the selected music track with the digital video file comprises synchronizing, by the computing device, the selected music track with the digital video advertisement.

22. The method of claim 21, wherein an event in the digital video advertisement is synchronized with an event in the selected music track.

23. The method of claim 1, further comprising selecting, by the computing device, a plurality of the candidate music tracks based upon the determined probability of a user interaction for each of the candidate music tracks.

24. A computerized system for generating a music track for playback in conjunction with display of a digital video advertisement, the system comprising a computing device configured to:
receive a request for a digital video advertisement from a user device;
determine a digital video advertisement based upon the request;
determine one or more attributes associated with the digital video advertisement;
identify one or more candidate music tracks based upon the one or more attributes associated with the digital video advertisement;
for each candidate music track, determine a probability of a user interaction with the digital video advertisement, the probability based upon the one or more attributes associated with the digital video advertisement and the candidate music track;
select one of the candidate music tracks based upon the determined probability for each of the candidate music tracks;
associate the selected music track with the digital video advertisement; and
transmit the digital video advertisement and the selected music track to the user device for playback.
